(19) United States
(12) Patent Application Publication
(10) Pub. No.: US 2012/0013515 A1
(43) Pub. Date: Jan. 19, 2012

(54) ROTATION MECHANISM FOR A COMMUNICATION ANTENNA

(76) Inventor: Zacharia Berejik, Tel-Aviv (IL)

(21) Appl. No.: 13/257,997

(22) PCT Filed: Mar. 23, 2010
(86) PCT No.: PCT/IL10/00242

§ 371 Date: Sep. 21, 2011

Related U.S. Application Data
(60) Provisional application No. 61/162,355, filed on Mar. 23, 2009.

(51) Int. Cl. H01Q 3/04; H01Q 1/12

(52) U.S. Cl. 343/766; 343/763

(57) ABSTRACT

A rotating antenna for radio frequency (RF) communication. The antenna comprises a pedestal and a rotating base supporting at least one antenna reflector and an RF transmission/reception unit, the pedestal and the rotating base being parallelly mounted, a rotary joint positioned to allow a transmission of radio frequency (RF) signals between the rotating base and the pedestal during a rotational motion of one relative to the other around a rotation axis, an encoder set to follow the rotational motion, a plurality slip rings positioned to encircle a vertical profile of the rotary joint between the pedestal and the rotating base so that an electric contact is maintained therebetween during the rotational motion, and an annular bearing positioned to radially encompass the encoder and the plurality slip rings around the rotation axis and to constrain the rotational motion. The rotary joint, the plurality slip rings, and the annular bearing are concentric and the rotary joint, the encoder, and the annular bearing being on a common horizontal plane.

### RELATED APPLICATION

This application incorporates by reference International Patent Application Publication No. WO2008/114246, published on Sep. 26, 2008. The contents of the above Application are incorporated herein by reference.

### FIELD AND BACKGROUND OF THE INVENTION

The present invention, in some embodiments thereof, relates to an apparatus and a method of RF communication antennas and, more particularly, but not exclusively, to an apparatus and a method of RF communication antennas for mobile platforms, such as vehicles, for example airplanes, trains, and cars, prefabricated structures, and moveable communication centers.

There is an increasing interest in implementing broadband communication systems on various forms of mobile platforms, for example, maritime vessels and land vehicles. With a broadband satellite communication system that has an antenna mounted on a vehicle, the antenna is used to help form a communication link with a space-based satellite in geosynchronous orbit. The antenna forms part of a communications terminal that is carried by the vehicle.

Antennas with an ability to track, with high precision, communication satellites from mobile platforms such as aircraft, ships and land vehicles are required, inter alia, for optimizing data rate, improving the efficiency of downlink and uplink transmission, and/or preventing interference with satellites orbiting adjacent to a target satellite. Such antennas allow mobile satellite communication platforms that have relatively high attitude accelerations, such as aircraft and land vehicles to receive signals from and/or to transmit signals to satellites such as geostationary satellites.

In order to collect the signals from the remote sources and/or in order to transmit signals to thereto, it is necessary to keep the antenna pointed at the satellite while taking the movement of a vehicle into account. In order to allow the antenna to point at the satellite, the vehicle-mounted antennas are made to track side-to-side (azimuth) and up and down (elevation). However, it should be noted that in order to avoid interfering with the smooth airflow over the vehicle or adversely affecting the aesthetics of the vehicle, the profile of the vehicle-mounted antennas has to remain low.

Low profile antennas for satellite communication are known. For example U.S. Patent Application Publication No. 2006/0197713, published on Sep. 7, 2006, describes a low profile receiving and/or transmitting antenna includes an array of antenna elements that collect and coherently combine millimeter wave or other radiation. The antenna elements are physically configured so that radiation at a predetermined wavelength band impinging on the antenna at a particular angle of incidence is collected by the elements and collected in-phase. Two or more mechanical rotators may be disposed to alter the angle of incidence of incoming or outgoing radiation to match the particular angel of incidence.

Another example is described in U.S. Patent Application Publication No. 2008/0246676, published on Oct. 9, 2008, that describes Antenna assembly for satellite tracking system that includes a plurality of antenna arrangements, each having one or more ports, and all ports connected through transmission lines in a combining/splitting circuit. The antenna arrangements form a spatial element array able to track a satellite in an elevation plane by mechanically dynamically rotating the antenna arrangements about transverse axis giving rise to generation of respective elevation angles and dynamically changing the respective distances between the axis whilst maintaining a predefined relationship between said distances and the respective elevation angles. The combining/splitting circuit provides phasing and signal delay in order to maintain pre configured radiating parameters. The arrangements can be mounted on a rotating platform to provide azimuth tracking. The system provides dynamic tracking of satellite signals and can be used for satellite communications on moving vehicles.

### SUMMARY OF THE INVENTION

According to some embodiments of the present invention there is provided a rotating antenna for radio frequency (RF) communication. The rotating antenna comprises a pedestal and a rotating base supporting at least one antenna reflector and an RF transmission/reception unit, the pedestal and the rotating base being parallelly mounted, a rotary joint positioned to allow a transmission of radio frequency (RF) signals between the rotating base and the pedestal during a rotational motion of one relative to the other around a rotation axis, an encoder set to follow the rotational motion, a plurality slip rings positioned to encircle a vertical profile of the rotary joint between the pedestal and the rotating base so that an electric contact is maintained therebetween during the rotational motion, and an annular bearing positioned to radially encompass the encoder and the plurality slip rings around the rotation axis and to constrain the rotational motion. The rotary joint, the plurality slip rings, and the annular bearing are concentric and the rotary joint, the encoder, and the annular bearing being on a common horizontal plane.

Optionally, the rotational motion comprises moving the rotational base from any rotational position in relation to the pedestal to any other rotational position in relation to the pedestal in no more than half a rotation in relation to the pedestal.

Optionally, the pedestal is mounted on a mobile platform comprising a power source, the electric contact being between the RF transmission/reception unit and the power source.

Optionally, the annular bearing having an outer bearing ring attached to a bottom of the rotating base and an inner bearing ring attached to the top of the pedestal.

Optionally, the rotating antenna comprises comprising an annular circumferential support gearwheel positioned to encircle the annular bearing and a motor configured for driving the rotational motion by actuating a motor gearwheel meshed with the annular circumferential support gearwheel.

Optionally, the annular circumferential support gearwheel is made from a material having a higher rigidity coefficient than the material of the motor gearwheel.

Optionally, the rotating antenna comprises comprising a gearwheel positioned to encircle the rotary joint and to support the rotation of the rotary encoder in a transmission ratio of 1:1 in relation to the pedestal.

More optionally, the gearwheel is made of a material having a low conductivity.

More optionally, the gearwheel having a common central axis with the annular bearing.

Optionally, the pedestal having a plurality of recesses for positioning supporting elements without increasing the vertical axis of the rotating antenna.

Optionally, slip rings are printed on a printed circuit board (PCB) having a projection, each the slip ring is electronically connected to at least one of a terminal and a power source via the projection.

Optionally, slip rings are printed on a first printed circuit board (PCB) and configured to be electronically connected to a plurality of slidable electrically-conductive interfaces printed on a second printed circuit board (PCB); wherein the first and second PCBs are parallelly attached to an inner ring of the annular bearing.

Optionally, the rotary joint, the plurality slip rings, and the annular bearing are parallelly mounted in a space having a vertical axis of less than 6 centimeters.

According to some embodiments of the present invention there is provided a rotating antenna for radio frequency (RF) communication. The rotating antenna comprises a pedestal having a board having a plurality of substantially concentric slip rings each physically connected to at least one of a power source and a communication terminal via a conductive element positioned along a horizontal projection in the board and a rotating base mounted substantially in parallel to the board while supporting a RF transmission/reception unit connected to at least one antenna reflector and having a plurality of slidable electrically-conductive interfaces each physically connected to the RF transmission/reception unit and configured for maintaining electrical contact with a different of the plurality of slip rings during a rotational motion of the rotating base in relation to the pedestal.

Optionally, the rotating antenna comprises an annular bearing located between the rotating base and the pedestal and encircling the slidable electrically-conductive interfaces and the slip rings.

Optionally, the RF transmission/reception unit comprises a block up converter (BUC) and the electrical contact allows transmitting an uplink signal from the communication terminal to the BUC during the rotational motion.

Optionally, the RF transmission/reception unit comprises a block down convertor (LNB) and the electrical contact allows transmitting a downlink signal from the LNB to the communication terminal during the rotational motion.

Optionally, the rotational base further comprises an actuation unit for tilting the at least one reflector, the electrical contact allows transmitting a tilting instruction from the communication terminal to the actuation unit during the rotational motion.

Optionally, the electrical contact allows powering the actuation unit.

Optionally, the electrical contact allows powering the RF transmission/reception unit.

Optionally, the slidable electrically-conductive interfaces are printed on a board.

Optionally, each the slidable electrically-conductive interface comprises at least one ball positioned in contact with at least one of the plurality of slip rings.

According to some embodiments of the present invention there is provided a method of radio frequency (RF) communication. The method comprises providing an antenna having a pedestal, a rotating base supporting at least one antenna reflector and an RF transmission/reception unit, and an annular bearing positioned between them to allow a rotational motion of the rotating base in relation to the pedestal, establishing at least one electrically-conductive connection between the RF transmission/reception unit and a communication terminal via the lumen of the annular bearing, driving the rotating base in the rotational motion while maintaining the at least one electrically-conductive connection, and using the at least one electrically-conductive connection for transmitting at least one of an uplink signal from the communication terminal to the RF transmission/reception unit and a downlink signal from the RF transmission/reception unit to the communication terminal.

Optionally, the method further comprises powering the RF transmission/reception unit using the at least one electrically-conductive connection.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary antenna for communicating with a remote communication system, according to some embodiments of the present invention;

FIG. 2 is a block diagram depicting the communication between a terminal and an antenna, such as the antenna depicted in FIG. 1 according to some embodiments of the present invention;

FIG. 3 is an upper schematic illustration of a segment of a rotation mechanism, according to some embodiments of the present invention;

FIG. 4 is a schematic illustration a board having a plurality of substantially concentric annular electrically-conductive elements, according to some embodiments of the present invention;

FIG. 5 is a sectional view of a segment of a rotational base that is mounted in parallel to a board that is attached to segment of a pedestal, according to some embodiments of the present invention;

FIG. 6 is section view of a gearwheel transmission unit that is connected to a mechanical rotary encoder and maintains a transmission ratio of 1:1 in relation to the rotation angle of the rotational base, according to some embodiments of the present invention;

FIG. 7 is a sectional schematic illustration of an exemplary rotation mechanism, according to some embodiments of the present invention;

FIG. 8 is a schematic illustration of an exemplary pedestal, according to some embodiments of the present invention; and

FIG. 9 is a schematic illustration of a vehicle on which the antenna is mounted.

### DESCRIPTION OF EMBODIMENTS OF THE INVENTION

The present invention, in some embodiments thereof, relates to an apparatus and a method of RF communication antennas and, more particularly, but not exclusively, to an apparatus and a method of RF communication antennas for mobile platforms, such as vehicles, for example airplanes, trains, and cars, prefabricated structures, and moveable communication centers.

According to some embodiments of the present invention, there is provided a rotating antenna having a rotation mechanism with a low profile, optionally with a height of less than 6 centimeters, for example 4 centimeters. Optionally, the rotating antenna, which is used for radio frequency (RF) communication includes a pedestal and a rotating base mounted in parallel thereto. The rotating base supports one or more antenna reflectors and an RF transmission/reception unit which is used for processing signals which are intercepted by the reflectors and/or transmitted therefrom. The rotating antenna further comprises a rotary joint for allowing the transmission of radio frequency signals between the rotating base and the pedestal. In such a manner, signals which are generated by a client terminal which is connected to the pedestal may be forwarded for transmission by the reflectors of the rotating base during a rotational motion of the rotating base in relation to the pedestal.

The rotating antenna includes slip rings which encircle the rotary joint. The slip rings maintain an electric contact during the aforementioned rotational motion. The slip rings may be used for powering the RF transmission/reception unit and transmitting serial data and intermediate frequency (IF) downlink and/or uplink signals thereto or therefrom.

The rotating antenna further comprises an annular bearing that is positioned to encircle the plurality slip rings between the pedestal and the rotating base so that the rotational motion is constrained. The rotary joint, the plurality slip rings, and the annular bearing are concentric.

Optionally, the RF transmission/reception unit includes an orthomode transducer (OMT) that is connected to up and/or down convertors. By physically connecting the slidable electrically-conductive interfaces to these convertors, the antenna may be connected to the communication terminals using standard coaxial cables.

According to some embodiments of the present invention, there is provided an antenna with a pedestal having substantially concentric annular electrically-conductive elements, such as slip rings printed on a printed circuit board (PCB) which are physically connected to one or more communication terminals and/or power sources which are external to the antenna. The rotating antenna further comprises a rotating base that is mounted in parallel to the slip rings while supporting a RF transmission/reception unit, which is connected to one or more antenna reflectors. The rotating base has a plurality of slidable electrically-conductive interfaces which are physically connected to the RF transmission/reception unit. Each one of the slidable electrically-conductive interfaces maintains electrical contact with one or more annular electrically-conductive elements during a rotational motion of the rotating base in relation to the pedestal. Optionally, the rotational motion and the annular electrically-conductive elements have a common rotation axis. The electrical contact allows transmitting uplink, downlink, control and/or feedback signals and/or messages between the communication terminals and the RF transmission/reception unit during the rotational motion and/or regardless to the rotational angle of the rotational base in relation to the pedestal. Alternatively or additionally, the electrical contact allows powering the RF transmission/reception unit.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

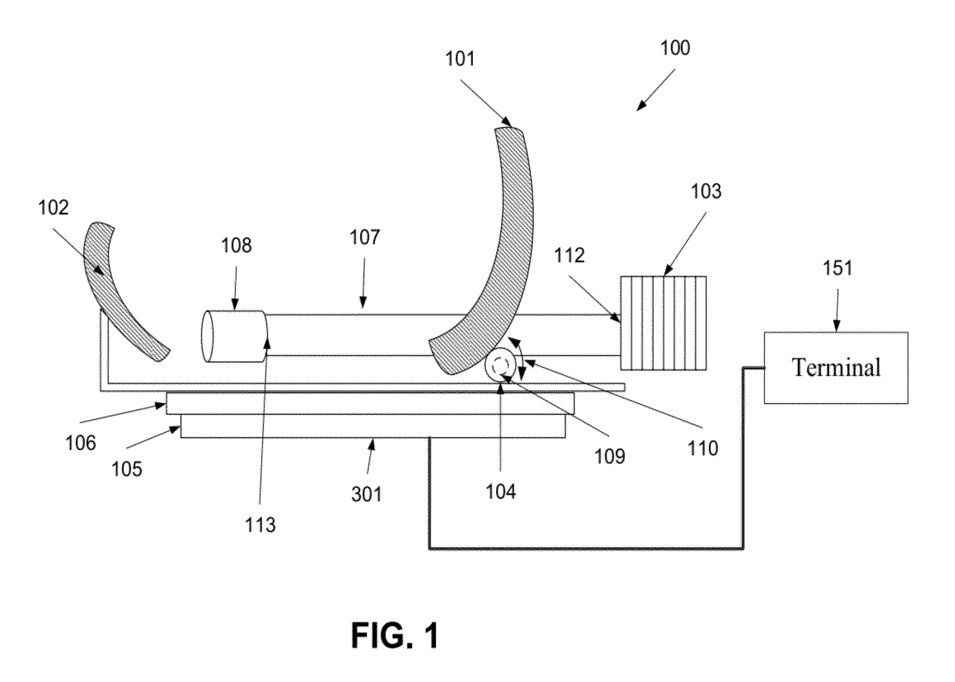

Reference is now made to FIG. 1, which is a schematic illustration of an exemplary antenna 100, which may be vehicle mounted, for communicating with a remote communication system, such as a satellite (not shown), according to some embodiments of the present invention. The exemplary antenna 100 may be a dual reflector antenna that comprises a set of reflectors for receiving and/or transmitting RF signals. As depicted in FIG. 1 the set of reflectors may comprise a main reflector 101 and a sub-reflector 102 which are facing one another, for example are described in International Patent Application Publication No. WO2008/114246, published on Sep. 26, 2008, which is incorporated herein by reference and may be referred to as WO2008/114246 International Patent Application. The antenna 100 further comprises a RF transmission/reception unit 103 for generating and/or intercepting communication signals. As used herein, a communication signal is a transmission signal, a satellite signal, and/or any communication system signal that is received by the antenna 100 and a RF transmission/reception unit 103 means a radio frequency (RF) transmitter, an RF receiver, a polarizing element, a transceiver, and/or any combination or portion thereof. Optionally, as depicted in FIG. 1, the RF transmission/reception unit 103 is positioned behind the main reflector 101. The RF transmission/reception unit 103 may comprise an OMT that combines and/or separates two RF signal paths. Optionally, the OMT is used for combining and/or separating between an uplink signal path and a downlink signal path, which are optionally transmitted over the same waveguide 107, for example as further described below. The OMT, which may be referred to as an OMT/polarizer, supports polarization of the communication signals which are received by and/or transmitted from the RF transmission/reception unit 103. The OMT supports circular polarization, such as left hand and right hand polarization, and/or linear polarization, such as horizontal and vertical polarization. The antenna 100 further comprises a waveguide 107 which may be referred to herein as a waveguide 107. The waveguide 107 has rear and front ends 112, 113. The rear end 112 is associated with a component of the RF transmission/reception unit 103 in a manner that allows it to emit the transmission signals which are generated by the RF transmission/reception unit 103 toward the sub-reflector 102, via the front end 113 that is optionally connected to a feed horn 108. It should be noted that the antenna may comprise various reflectors and/or RF transmission/reception unit 103, as known in the art.

Optionally, the main reflector 101 is connected to one or more supporting elements 104 that allows the tilting thereof around a tilting axis 109 that is parallel to a rotational base 106, for example as shown at 110. The supporting elements 104 may be used for tilting only the main reflector 101 in relation to the rotational base 106. The tilting axis 109 is connected to an actuation unit, such as servomotor, which is designed to drive the rotation thereof for allowing the tilting of the main reflector. The rotational base 106 is connected to an actuation unit, such as servomotor, which is designed to drive the rotation thereof for allowing the rotation of the reflectors 101, 102, the waveguide 107, and the RF transmission/reception unit 103 in relation to the pedestal 105. The actuation units are optionally controlled by a controller, such as a micro-computer based controller equipped with digital signal processor (DSP). The controller controls the actuation units, which are optionally servomotors, by changing their speed and/or by applying different speed functions in different tracking patterns. In addition, a position sensor, such as a rotary encoder and/or a linear speed sensor are equipped in the actuation units and/or the rotational base 106 and/or the tilting axis. These sensors may release signals to the DSP to achieve feedback control.

Optionally, the antenna 100 further comprises a pedestal 105 that allows attaching it to stationary and/or mobile surfaces, such as a roof of a mobile platform, for example a train, an automobile, a track, a bus, a boat, a ship, a plane, a helicopter, a hovercraft, a shuttle, and any other conveyance that transports people and/or objects. The pedestal 105 is connected to a rotational base 106 that allows the rotation of the set of reflectors 101, 102, the waveguide 107, and the RF transmission/reception unit 103 or any portion thereof.

The antenna 100 is connected to one or more transmission and/or reception terminal, and optionally to a power supply, which allow a user and/or a system to receive data that is intercepted by the antenna 100, for example a downlink, to transmit data using the antenna 100, for example an uplink, to control the to control the directivity of the antenna 100, for example by instructing the actuation units, and/or to receive a feedback from the antenna's controller when the rotational base is rotated.

Optionally, the rotational base 106 includes a rotation mechanism that allows sequentially rotating the reflectors, which are attached to the rotational base 106, clockwise to any combination of transmission and/or reception angles without having to rotate it counterclockwise or vice versa. In such a manner, the rotational angle of the reflectors 101, 102, the waveguide 107, and the RF transmission/reception unit 103 may be adjusted by the fastest rotation operation, regardless to the current transmission and/or reception angle of the rotational base 106. Optionally, all the communication and/or the power lines of the antenna are passing through the body of the antenna 100. In such a manner, wires and/or any other electrically-conductive elements are not entangled during the rotational motion of the rotational base.

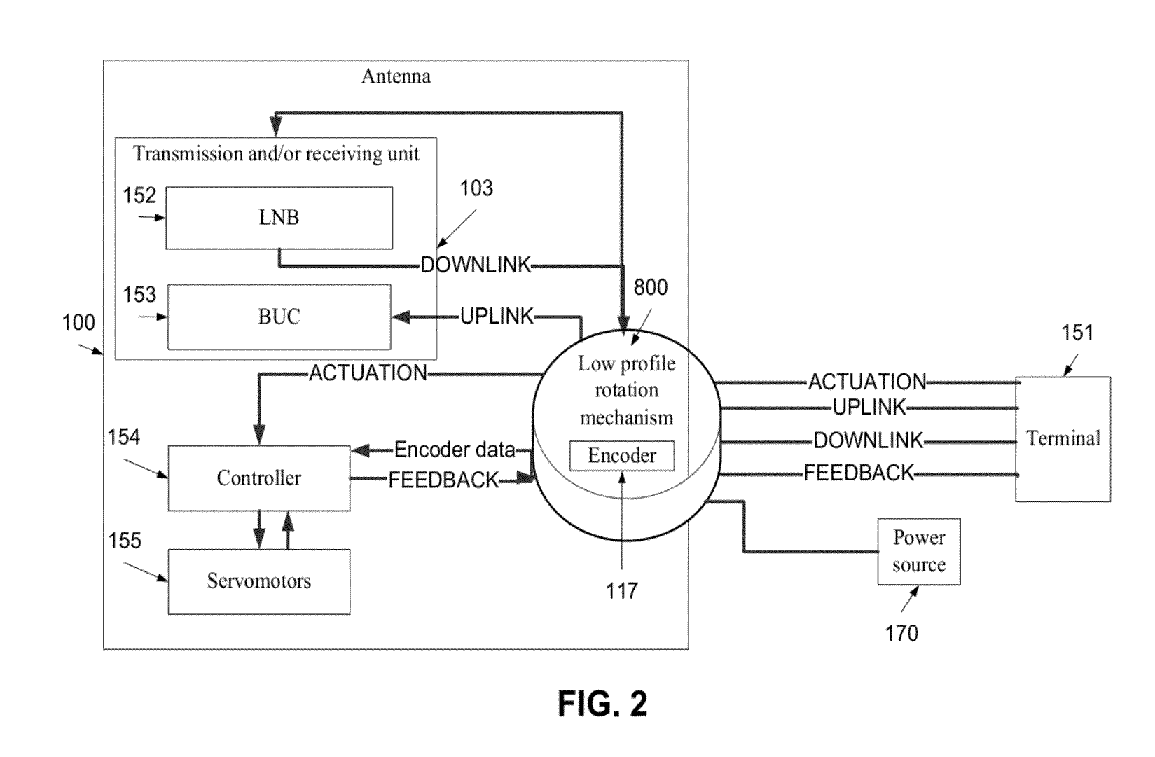

Reference is now also made to FIG. 2, which is a block diagram depicting the communication between a terminal 151, such as a client terminal based on the communication with the antenna 100, and the antenna 100, according to some embodiments of the present invention. The client terminal may be a personal computer, a satellite phone terminal, or a personal digital assistance (PDA), and/or any computing device executing a communication application.

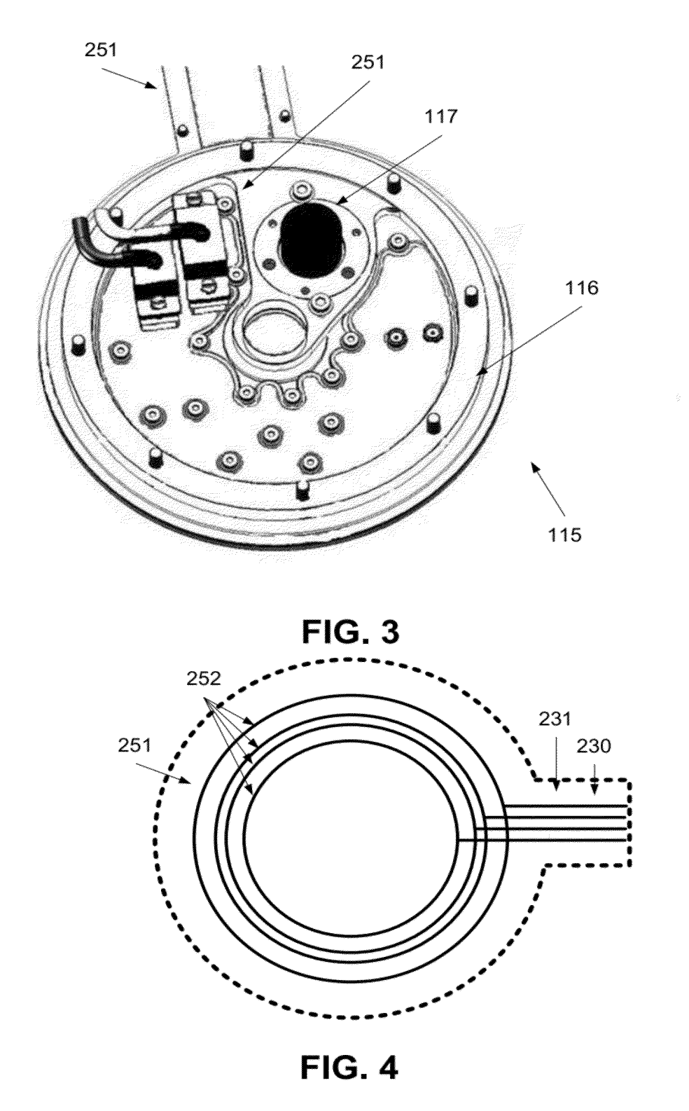

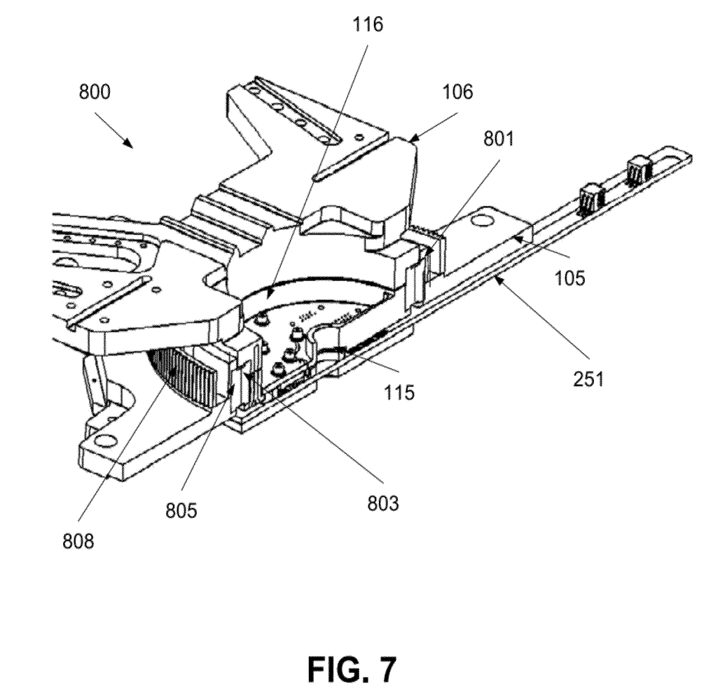

As depicted in FIG. 2, according to some embodiments of the present invention, all the communication signals are transferred over a number of wired communication lines which are passing through a rotation mechanism 800. The communication signals include serial data, absolute or incremental angular positioning generated by an encoder which is connected to the rotational base, and intermediate frequency (IF) downlink and/or uplink signals. Optionally, the rotation mechanism 800 includes an encoder 117 that allows the measuring of the current rotation angle of the rotational base 106 in relation to the current rotation angle of the pedestal 105. The encoder's outputs are optionally forwarded to the terminal 151. The rotation mechanism 800 has a low profile. In such a manner, the rotation mechanism 800 reduces the longitudinal profile and the wind drag that is incurred by the antenna 100 and increases its survivability. As used herein, the longitudinal profile of the rotation mechanism is less than 6 centimeters (cm), for example 4. Optionally, the low profile is allowed because of a unique arrangement of rotating elements around the rotational axis of the rotational base, for example an encoder, conductive elements, and an annular bearing, for example as depicted in FIGS. 3 and 7 and described below.

Optionally, the rotation mechanism 800 includes electrically-conductive elements which are firmly fixed to the rotational base 106 and electronically connected to electrically-conductive elements which are firmly fixed to the pedestal 105. These elements maintain communication and/or power supply during the rotation of the rotational base 106 in relation to the pedestal 105, as further described below. In such a manner, the reflectors, which are connected to the rotational base, may be rotated from a certain rotational angle, substantially in parallel to the horizontal plane of the pedestal 105, to any other rotational angle, in rotational motion of less than 180° without disconnecting data transmission and/or communication between the antenna 100 and the terminal 151. In such am manner, the rotational base 106 may continuously rotate, to any of rotational angle between 0.01° and 360° in the shortest rotational motion.

Optionally, the rotation mechanism 800 comprises an annular bearing for constraining the movement of the rotational base 106 in relation to the pedestal 105, for example as described below and depicted in FIG. 7. In such an embodiment, the communication and/or power lines between the terminal 151 and the antenna 100 may pass through the lumen of the annular bearing. Optionally, all the communication and/or power lines between the terminal 151 and the antenna 100 pass through the rotation mechanism 800.

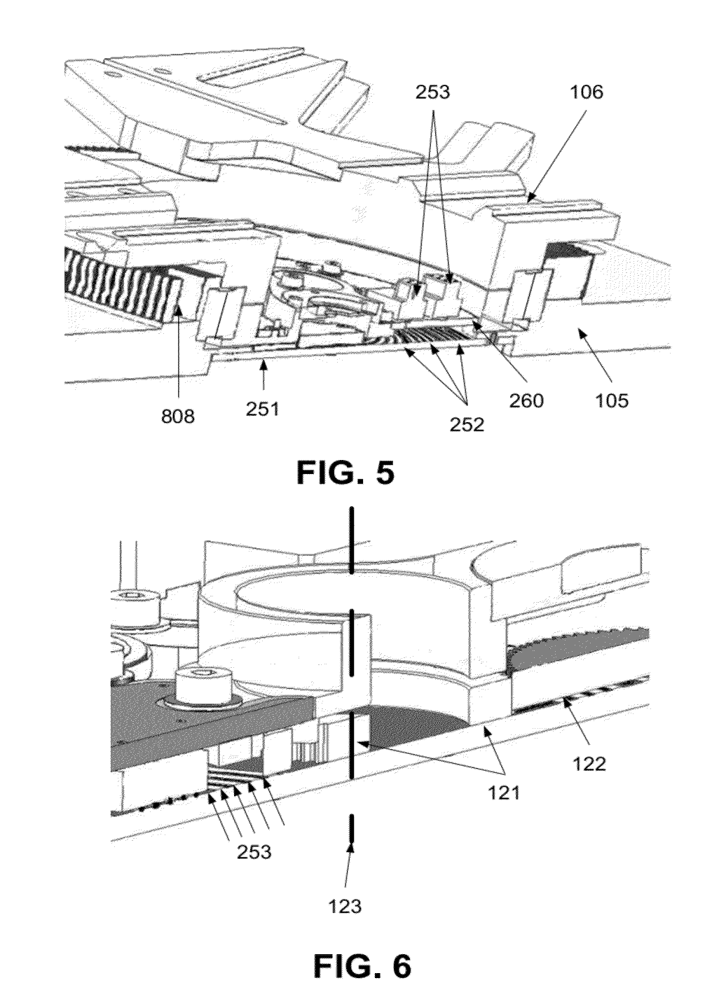

Optionally, as further described below and depicted in FIGS. 5 and 7, the annular bearing encircles the aforementioned conductive elements and the encoder 117. In such a manner, the elements are not stack one on top of the other but positioned in parallel to one another. The encoder and the conductive elements are positioned in an area that is bounded by the annular bearing and has a longitudinal profile of less than 6 centimeters, for example 4 centimeters.

As depicted in FIG. 2, power from a power source 170 may be forwarded to the RF transmission/reception unit 103 and/or to the controller 154, and/or to the servomotors 155 during a rotational motion of the rotational base 106 in relation to the pedestal 105 that is attached to a surface of a mobile platform. In such an embodiment, the power source may be positioned in or in proximity to the mobile platform.

Optionally, one or more of the electrically-conductive elements are designed to forward downlink signals, which are intercepted by the reflectors 101, 102 and forwarded to the RF transmission/reception unit 103, to the terminal 151. For example, the broadcast signals from the satellite are directed toward a low noise block down convertor (LNB) 152 that converts the broadcast signals to a lower frequency. For example, the LNB 152 receives the signal in 12.2-12.7 GHz range and converts it into a 950-1450 MHZ signal, which may be easily sent over a standard coaxial cable. The output of the LNB is forwarded to the terminal 151 via a respective conducting element of the rotational base, fitted to the cable impedance.

Optionally, one or more of the electrically-conductive elements are designed to forward uplink signals from the terminal 151, via the OMT, to the feed-horn 108 that faces the reflector 102. In use, uplink signals which are generated and/or modulated by the terminal 151 are forwarded to the RF transmission/reception unit 103. For example, the signals to a satellite are directed toward a block up converter (BUC) 153 for an uplink transmission of satellite signals. The BUC 153 converts a band of frequencies from a lower frequency to a higher frequency, for example from 1.50 GHz to between 13.75 GHz and 14.5 GHz. Optionally, The BUC 153 converts the signals from the L band to Ku band, C band and Ka band.

Optionally, one or more of the electrically-conductive elements are designed to forward actuation instructions from the terminal 151 to the actuation units 155 that maneuver the rotational base 106 and/or the reflector 101 of the antenna 100. In use, actuation instructions are generated by the terminal 151, for example according to input of a user that directs the reflectors to a certain angle, and forwarded to the controller 154 that controls the actuation units accordingly. For example, the controller may instruct servomotors which are connected to the rotational base 106 and/or tilting axis 109.

Optionally, one or more of the electrically-conductive elements are designed to forward feedback from the components of the antenna to the terminal 151. In use, the feedback is generated by the controller 154 of the antenna and/or by any other units thereof and forwarded to the terminal 151 that optionally presents the feedback to the user, for example on a display, and/or alarms the user accordingly. For example, the controller may instruct servomotors which are connected to the rotational base 106 and/or the tilting axis 109.

The communication, which is described in FIG. 2, allows receiving the downlink signals, transmitting the uplink signals, receiving the feedback, and/or forwarding the actuation instructions during a rotational motion of the rotational base 106 in relation to the pedestal 105. This communication is possible as the electrically-conductive elements maintain electrical contact with the terminal during the rotational motion of the rotational base 106.

Reference is now also made to FIG. 3, which is an upper schematic illustration of a segment of the rotation mechanism 800, according to some embodiments of the present invention. The rotation mechanism 800 includes a rotational base segment 116 which is mounted, in parallel or substantially in parallel, to a pedestal segment 115 having a communication board, such as a bottom PCB 251 that is directly connected to the pedestal 105. In such an embodiment, a number of electrically-conductive elements 252 are separately printed on the bottom PCB 251.

As depicted in FIG. 3, a tubular cavity is formed in the center of the rotation mechanism, concentrically to the central rotation axis of the rotational base segment 116 in relation to the pedestal segment 115. Optionally, a rotary joint that is designed for transferring intermediate frequency signals (IF) is positioned in the tubular cavity. The vertical profile of the rotary joint is optionally less than 6 centimeters, for example 4 cm, and therefore does not increase the vertical profile of the rotation mechanism 800.

Reference is also made to FIG. 4, which is a schematic illustration the bottom PCB 251 having a plurality of substantially concentric annular electrically-conductive elements 252, such as slip rings 252, which are separately and electronically connected to the terminal 151 via a horizontal projection 231, according to some embodiments of the present invention. As used herein, substantially concentric elements means elements, such as concentric rings made of wires, which are positioned to have a common center and/or a number of centers which are no more than few millimeters and/or centimeters away from one another. For brevity, the substantially concentric annular electrically-conductive elements may be referred to herein as slip rings. Optionally, each slip ring is connected to a trace on the PCB that is positioned along the horizontal projection 231. In such a manner, each ring and its physical connection to the client terminal and/or to the power source are positioned on the same plane. This configuration has a low profile which his defined by the thickness of the printed board 251.

Optionally, each slip ring 252 may comprise one or more slip rings. Optionally, the slip rings are mounted on the bottom PCB 251. Optionally, the slip rings are fixated with a solder. As the slip rings 252 are arranged in a common plane, for example printed on single PCB, they do not substantially increase the vertical profile of the antenna 100.

Reference is also made to FIG. 5, which is a sectional view of the rotational base segment 116 that is mounted in parallel to the bottom PCB 251 that is attached to the pedestal 105, according to some embodiments of the present invention. As described above, the antenna 100 is designed to maintain electrical contact with the terminal during the rotational motion of the rotational base 106 in relation to the pedestal that is attached to a surface of a mobile platform, such as vehicle. The electrical contact allows maintaining the one or more of the aforementioned communication and power lines during the rotational motion of the rotational base 106.

In order to maintain electrical contact between the rotational base 106 and the pedestal 105 while one is rotated in relation to the other, the rotational base segment 116 comprises a set of slidable electrically-conductive interfaces 253 which are designed to maintain contact with the plurality of substantially concentric slip rings 252 at the pedestal segment 115. Each one of the slidable electrically-conductive interfaces 253 having a connection to a conducting element, such as a wire, which is connected to the controller 154 and/or to the RF transmission/reception unit 103, for example to the BUC or the LNB, as depicted in FIG. 2. In addition, each slidable electrically-conductive interface 253 is designed to be electronically connected to one of the slip rings 252 during the rotational movement. The slidable electrically-conductive interfaces 253 are positioned to be guided above one of the slip rings 252 during the rotational movement, optionally while applying pressure thereon. Optionally, each slidable electrically-conductive interface 253 is housed within a protective container that fixes its location in parallel and above a concentric slip ring 252 during the rotational motion of the rotational base. Optionally, the slidable electrically-conductive interface 253 is a leaf spring and/or a helical spring that is contracted above the slip ring 252. Optionally, each slidable electrically-conductive interface 253 comprises one or more balls which are confined in a housing between one of the slip rings 252. The balls reduce the rotational friction between the respective slip ring 252 and the slidable electrically-conductive interface 253 while maintaining electric contact between them.

The electrical contact between the slidable electrically-conductive interfaces 253 and the slip rings 252, which may be referred to herein as slip rings 252, allow transferring serial data, electrical power, and low frequency RF signals, such as intermediate frequency (IF) between the pedestal 105 and the rotating base 106.

Optionally, the electrically-conductive interfaces 253 are integrated into a board 260, such as a PCB 260, which is mounted on top and in parallel to the bottom PCB. The PCB 260 is optionally firmly attached the inner, optionally lower, side of the bearing 805.

Optionally, the joint vertical profile of the board that is printed with the slip rings 252 and the slidable electrically-conductive interfaces 253 is less than 6 centimeters thick, for example 4 centimeters.

Optionally, in order to avoid the use of protruding wires, the lower PCB 251 extends through one or more recesses in the pedestal 105. The recesses allow integrating the lower PCB 251 with the pedestal 105 without increasing the vertical axis of the antenna 100.

As described above, the rotation mechanism 800 allows the rotation of the rotational base 106 in parallel to the pedestal 105. In order to track the angle of the rotational base 106 in relation to the pedestal 105, the rotation mechanism 800 includes the encoder 117, such as a mechanical absolute encoders, for example absolute rotary encoder, incremental rotary encoder and/or optical encoder. The encoder 117 measures the angular position of the rotating base 106 in relation to the pedestal 105. Optionally, the encoder is a rotary encoder with a shaft inserted into or toward the lower PCB 251. In such a manner, the encoder does vertical profile is similar to the vertical profile of the rotation mechanism 800. The encoder's shaft is placed aside from the center rotational axis of the antenna, in the center of a shaft gearwheel 122 that rotates around a support gearwheel which is fixated so that its center is on the center rotational axis of the antenna. In such a manner, the rotary encoder maintains a 1:1 transmission ratio. For example, FIG. 6 is section view that depicts a transmission unit that is connected to the encoder and includes an encoder support gearwheel 121, positioned on the central rotation axis 123 of the bearing of the rotation mechanism 800, and the shaft gearwheel 122 that is positioned to rotate around it. These gearwheels 121, 122 allow the transmission unit to maintain a transmission ratio of 1:1 in relation to the rotation angle of the rotational base 106. In such a manner, the encoder 117 may detect the rotational angle of the rotational base 106 in relation to the pedestal 105 in any given moment without having to record data about previous rotational angles of the rotational base 106. The encoder 117 may provide the current rotational angle of the reflectors of the antenna 100 without performing a calibration in addition to the initial factory calibration and/or the antenna 100 fixation. Optionally, the transmission unit comprises gearwheels which are made from a non conducting material, such as a polymeric material. In such a manner, short circuits, which may have been caused by an unplanned contact between the gear transmission 121, 122 and the slip rings 252, are avoided.

Optionally, the encoder support gearwheel 121 encircles a rotary joint rotary joint that transfers IF signals around the rotation axis 123. It should be noted that the rotary joint, the encoder, and the annular bearing are traversed by a common horizontal plane which is parallel to the central horizontal axis of the rotational base 106 and the pedestal 105.

Optionally, the encoder support gearwheel 121 and the slip rings 252 are concentric.

Optionally, a rotation motor-drive (not shown), such as a servomotor is attached to the rotational base 106 and used for rotating the rotational base 106 in relation to the current rotation angle of the pedestal 105. In such an embodiment, a circumferential support gearwheel 808 or a corrugated surface is attached to and/or engraved on an outer ring 805 of the bearing of the rotation mechanism 800, optionally in the upper section thereof, and used as an opposing support surface for the transmission of rotational power by the rotation motor-drive that is attached to the rotational base 106. The lower surface outer ring 805 is optionally firmly attached to the pedestal 105. Optionally, the circumferential support gearwheel 808, the slip rings 252, and the encoder support gearwheel 121 are concentric to one another.

The gear wheel (not shown) attached to the circumferential support gearwheel 808 is designed to become eroded faster then the circumferential support gearwheel 808. In such a manner, the attached gearwheel, which may be replaced relatively easily, is eroded faster than the circumferential support gearwheel 808 and therefore replaced for proper functioning before the circumferential support gearwheel 808 may be damaged. In such a manner, the antenna may be maintained and/or repaired without excessive disassembly of the rotation mechanism 800. Optionally, the circumferential support gearwheel 808 is made from a material having a higher rigidity coefficient than the material of the attached gearwheel. In such a manner, the attached gear wheel (not shown) attached to the support gearwheel 808 is eroded before the circumferential support gearwheel 808 is damaged.

In some embodiments of the present invention, the rotation mechanism 800 is used for rotating a reflector and an RF transmission/reception unit of a radio detection and ranging (radar) system. In such an embodiment, the terminal is a radar terminal and the signals are IF of RF energy pulses and their echoes from remote objects instead of uplink and downlink signals.

Optionally, the rotation mechanism 800 is inverted around the horizontal axis. In such an embodiment, the slip rings 252 are above the aforementioned slidable electrically-conductive interfaces 253 and the encoder 170. In such an embodiment, the slip rings 252 are attached to the rotational base and the aforementioned slidable electrically-conductive interfaces 253 and the encoder 170 are attached to the pedestal.

Optionally, the slip rings 252 are attached to the rotational base 106 and the set of slidable electrically-conductive interfaces 253 are attached to the pedestal 105. In such an embodiment, the aforementioned description applies, mutatis mutandis.

Reference is now made to FIG. 7, which is a sectional schematic illustration of an exemplary rotation mechanism 800, according to some embodiments of the present invention. In order to allow a constrained relative rotational motion between the pedestal 105 and the rotational base 106, the rotation mechanism 800 includes an annular bearing 801, for example a ball bearing, with a relatively large diameter in relation to the rotational base 106, for example more than 12 centimeters, for example 15. Optionally, the bearing 801 radially encompass encircles the aforementioned slidable electrically-conductive interfaces 253, the rotary joint, and the slip rings 252 and constrain the rotational motion of the slidable electrically-conductive interfaces 253 on the slip rings 252. In such a manner, the height of an assembly that includes the bearing 801, the rotary joint, and the slip rings 252 equals to the height of the element that has the longest vertical axis, for example the rotary joint, and not stack one on top of the other. Optionally, the vertical axis of the rotary joint is less than 6 centimeter. The bearing 801 radially encompass at least a portion of the vertical profile of the rotary joint and slip rings 252.

The bearing 801 is parallelly mounted between the rotational base 106 and the pedestal 105. Optionally, the bearing 801 comprises inner and outer rings 803, 805.

Optionally, the pedestal 105 is attached to the outer ring 805 and the rotational base segment 116 is attached to the inner ring 803, above a pedestal segment 115 that is confined by the bearing 801. In such an embodiment, the underside of the rotational base 106 includes the slidable electrically-conductive interfaces 253 that allow the connecting of components of the RF transmission/reception unit 103 and/or the controller of actuation units to the terminal 151, the power source 170 and optionally to other units such as a central controller, and/or any other unit that may be placed in the mobile platform. The lower side of the inner ring is firmly attached to the bottom PCB 251 that is printed with the slip rings 252 which are electronically connected to the slidable electrically-conductive interfaces 253 and allow the passage of power and/or signals therefrom and/or thereto in any rotational angle of rotational base 106 in relation to the bottom PCB 251 that is optionally firmly attached to the pedestal 105.

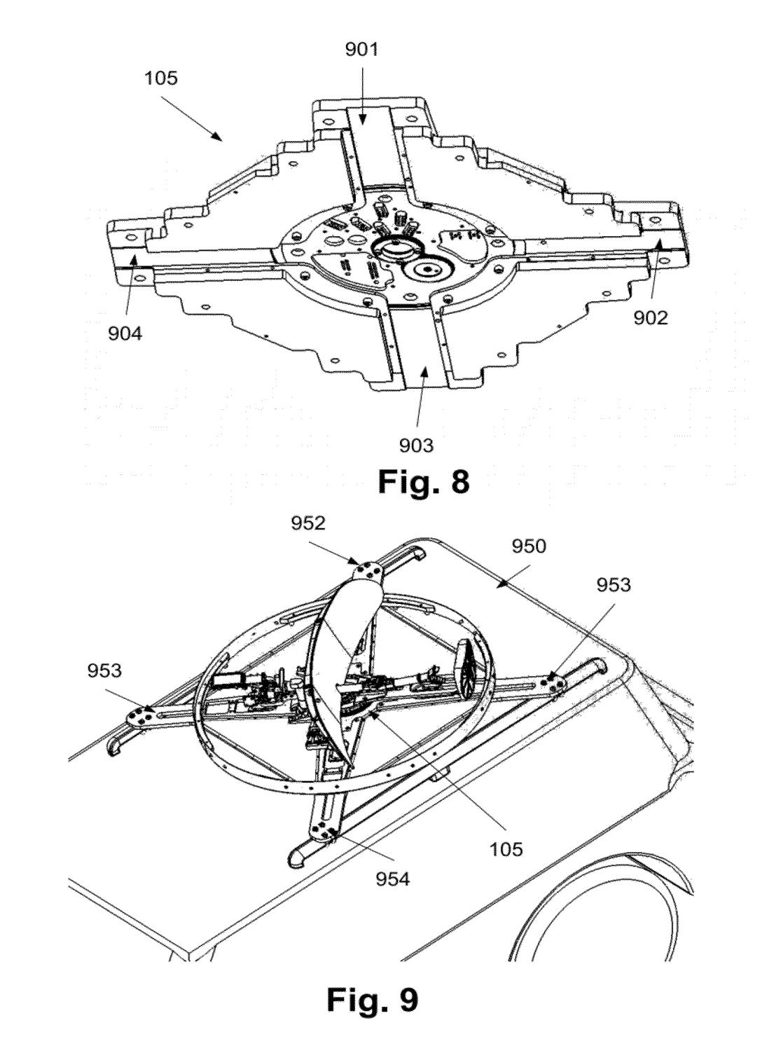

In some embodiment of the present invention, the pedestal 105 is designed to be connected to four mechanical arms. As shown at FIG. 8 which is a schematic illustration of an exemplary pedestal, according to some embodiments of the present invention, the pedestal 105 optionally has four recesses 901-904 that allows the attaching of four supporting arms without substantially elevating the vertical profile of the antenna 100. The supporting arms are designed to be attached to a mobile platform and to bear the weight of the antenna 100. For example, FIG. 9 depicts an exemplary connection between the antenna 100 and a vehicle 950. Optionally, the supporting arms 952-955 are made of a relatively light metal, such as aluminum. It should be noted that the weight that is applied on the supporting arms may increase due to the movement of the antenna and/or the platform.

It is expected that during the life of a patent maturing from this application many relevant methods and systems will be developed and the scope of the term communication, transmission, is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, an and the include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A rotating antenna for radio frequency (RF) communication, comprising:
a pedestal and a rotating base supporting at least one antenna reflector and an RF transmission/reception unit, said pedestal and said rotating base being parallelly mounted;
a rotary joint positioned to allow a transmission of radio frequency (RF) signals between said rotating base and said pedestal during a rotational motion of one relative to the other around a rotation axis;
an encoder set to follow said rotational motion;
a plurality slip rings positioned to encircle a vertical profile of said rotary joint between said pedestal and said rotating base so that an electric contact is maintained therebetween during said rotational motion; and
an annular bearing positioned to radially encompass said encoder and said plurality slip rings around said rotation axis and to constrain said rotational motion;
wherein said rotary joint, said plurality slip rings, and said annular bearing are concentric and said rotary joint, said encoder, and said annular bearing being on a common horizontal plane.

2. The rotating antenna of claim 1, wherein said rotational motion comprises moving said rotational base from any rotational position in relation to said pedestal to any other rotational position in relation to said pedestal in no more than half a rotation in relation to said pedestal.

3. The rotating antenna of claim 1, wherein said pedestal is mounted on a mobile platform comprising a power source, said electric contact being between said RF transmission/reception unit and said power source.

4. The rotating antenna of claim 1, wherein said annular bearing having an outer bearing ring attached to a bottom of said rotating base and an inner bearing ring attached to the top of said pedestal.

5. The rotating antenna of claim 1, further comprising an annular circumferential support gearwheel positioned to encircle said annular bearing and a motor configured for driving said rotational motion by actuating a motor gearwheel meshed with said annular gearwheel.

6. The rotating antenna of claim 5, wherein said annular circumferential support gearwheel is made from a material having a higher rigidity coefficient than the material of motor gearwheel.

7. The rotating antenna of claim 1, further comprising a gearwheel positioned to encircle said rotary joint and to support the rotation of said rotary encoder in a transmission ratio of 1:1 in relation to said pedestal.

8. The rotating antenna of claim 7, wherein said gearwheel is made of a material having a low conductivity.

9. The rotating antenna of claim 7, wherein said gearwheel having a common central axis with said annular bearing.

10. The rotating antenna of claim 1, wherein said pedestal having a plurality of recesses for positioning supporting elements without increasing the vertical axis of the rotating antenna.

11. The rotating antenna of claim 1, wherein slip rings are printed on a printed circuit board (PCB) having a projection, each said slip ring is electronically connected to at least one of a terminal and a power source via said projection.

12. The rotating antenna of claim 1, wherein slip rings are printed on a first printed circuit board (PCB) and configured to be electronically connected to a plurality of slidable electrically-conductive interfaces printed on a second printed circuit board (PCB); wherein said first and second PCBs are parallelly attached to an inner ring of said annular bearing.

13. The rotating antenna of claim 1, wherein said rotary joint, said plurality slip rings, and said annular bearing are parallelly mounted in a space having a vertical axis of less than 6 centimeters.

14. A rotating antenna for radio frequency (RF) communication, comprising:
a pedestal having a board having a plurality of substantially concentric slip rings each physically connected to at least one of a power source and a communication terminal via a conductive element positioned along a horizontal projection in said board; and
a rotating base mounted substantially in parallel to said board while supporting a RF transmission/reception unit connected to at least one antenna reflector and having a plurality of slidable electrically-conductive interfaces each physically connected to said RF transmission/reception unit and configured for maintaining electrical contact with a different of said plurality of slip rings during a rotational motion of said rotating base in relation to said pedestal.

15. The rotating antenna of claim 14, further comprising an annular bearing located between said rotating base and said pedestal and encircling said slidable electrically-conductive interfaces and said slip rings.

16. The rotating antenna of claim 14, wherein said RF transmission/reception unit comprises a block up converter (BUC) and said electrical contact allows transmitting an uplink signal from said communication terminal to said BUC during said rotational motion.

17. The rotating antenna of claim 14, wherein said RF transmission/reception unit comprises a block down convertor (LNB) and said electrical contact allows transmitting a downlink signal from said LNB to said communication terminal during said rotational motion.

18. The rotating antenna of claim 14, wherein said rotational base further comprises an actuation unit for tilting said at least one reflector, said electrical contact allows transmitting a tilting instruction from said communication terminal to said actuation unit during said rotational motion.

19. The rotating antenna of claim 18, wherein said electrical contact allows powering said actuation unit.

20. The rotating antenna of claim 14, wherein said electrical contact allows powering said RF transmission/reception unit.

21. The rotating antenna of claim 14, wherein said plurality of slidable electrically-conductive interfaces are printed on a board.

22. The rotating antenna of claim 14, wherein each said slidable electrically-conductive interface comprises at least one ball positioned in contact with at least one of said plurality of slip rings.

23. A method of radio frequency (RF) communication, comprising:
providing an antenna having a pedestal, a rotating base supporting at least one antenna reflector and an RF transmission/reception unit, and an annular bearing positioned between them to allow a rotational motion of said rotating base in relation to said pedestal;
establishing at least one electrically-conductive connection between said RF transmission/reception unit and a communication terminal via the lumen of said annular bearing;
driving said rotating base in said rotational motion while maintaining said at least one electrically-conductive connection; and
using said at least one electrically-conductive connection for transmitting at least one of an uplink signal from said communication terminal to said RF transmission/reception unit and a downlink signal from said RF transmission/reception unit to said communication terminal.

24. The method of claim 23, further comprising powering said RF transmission/reception unit using said at least one electrically-conductive connection.

25. The rotating antenna of claim 11, wherein said projection extends through at least one recess in said pedestal so as to allow integrating said PCB without increasing the vertical axis of said rotating antenna.
